(19) United States
(12) Patent Application Publication
(10) Pub. No.: US 2011/0041635 A1
(43) Pub. Date: Feb. 24, 2011

(54) TRANSMISSION

(75) Inventors: Ping-Sheng LIU, Changhua County (TW); Chih-Siang CHEN, CHANGHUA COUNTY (TW)

Correspondence Address: BRIAN M. MCINNIS, 12th Floor, Ruttonjee House, 11 Duddell Street, Hong Kong, HK

(73) Assignee: Chih-Siang CHEN, CHANGHUA COUNTY (TW)

(21) Appl. No.: 12/859,784

(22) Filed: Aug. 20, 2010

(30) Foreign Application Priority Data
Aug. 21, 2009 (TW) 98128258

(51) Int. Cl. F16H 3/08

(52) U.S. Cl. 74/319

(57) ABSTRACT

A transmission includes a body, a transferring gear set, a driving gear set, a reversible gear set, a unidirectional gear set, a wedge and a switcher. The body is mounted on a wheel. The transferring gear set includes a driving shaft and a transferring gear. The driving gear set includes a wheel hub and a driving gear. The reversible gear set includes a reversible sleeve and a reversible gear. The unidirectional gear set includes a follower gear, a unidirectional clutch and a unidirectional sleeve. The unidirectional clutch engages the reversible sleeve to the follower gear when the reversible sleeve is rotated in a first direction and disengages the reversible sleeve from the follower gear when the reversible sleeve is rotated in a second direction. The switcher moves the wedge to engage the recesses of the unidirectional sleeve and the reversible sleeve.

### RELATED APPLICATIONS

The application claims priority to Taiwan Application Serial Number 98128258, filed Aug. 21, 2009, which is herein incorporated by reference.

### BACKGROUND

1. Technical Field

The present disclosure relates to a transmission device of a vehicle.

2. Description of Related Art

There are many vehicles used for transportation or for exercise. Vehicles includes motor vehicles, trailers, traction engines, farm tractors, road-building machines, bicycles and any vehicle drawn, propelled or driven by any kind of power. Vehicles use different means to permit or ease movement. These are commonly in the form of wheels, boat or submarine hulls, skis, caterpillar tracks, skates, wings, rotors or cushions of air or jets of air.

A transmission or gearbox provides speed and torque conversions from a rotating power source to another device using gear ratios. The transmissions are commonly used on pedal bicycles, fixed machines, and anywhere else rotational speed and torque needs to be adapted.

A freehub or overrunning clutch is a device used in the pedal bicycles. The freehub or overrunning clutch is in a transmission that disengages the driveshaft from the driven shaft when the driven shaft rotates faster than the driveshaft. The condition of a driven shaft spinning faster than its driveshaft exists in most bicycles when the user holds his or her feet still, no longer pushing the pedals. Therefore, the freehub setup naturally results in user's being able to pedal backwards without the teeth on the chain assembly engaging the chain. Without the mode of moving backward, it is inconvenient for user to deal with the situations such as packaging goods, crossing waterlogged or narrow lanes, the user has to get off the bicycle then move it backward by hands.

### SUMMARY

According to one embodiment of the present invention, a transmission includes a body, a transferring gear set, a driving gear set, a reversible gear set, a unidirectional gear set, a wedge and a switcher. The body is mounted on a wheel. The transferring gear set includes a driving shaft and a transferring gear. The driving shaft is pivotally connected to the body. The transferring gear is connected to the driving shaft. The driving gear set includes a wheel hub and a driving gear. The wheel hub is pivotally connected to the driving shaft of the transferring gear set for driving the wheel. The driving gear is mounted on the wheel hub. The reversible gear set includes a reversible sleeve and a reversible gear. The reversible sleeve has a plurality of recesses therein and is pivotally connected to the body. The reversible gear is connected to the reversible sleeve and meshes with the transferring gear of the transferring gear set. The unidirectional gear set includes a follower gear, a unidirectional clutch and a unidirectional sleeve. The follower gear meshes with the driving gear of the driving gear set. The unidirectional clutch engages the reversible sleeve of the reversible gear set to the follower gear when the reversible sleeve of the reversible gear set is rotated in a first direction and disengages the reversible sleeve of the reversible gear set from the follower gear when the reversible sleeve of the reversible gear set is rotated in a second direction. The unidirectional sleeve is connected to the follower gear and has a plurality of recesses therein. The switcher moves the wedge to engage the recesses of the unidirectional sleeve and the recesses of the reversible sleeve.

According to another embodiment of the present invention, a transmission includes a body, a transferring gear set, a driving gear set, a reversible gear set, a unidirectional gear set and a switcher. The body has a hollow axle. The transferring gear set includes a driving shaft and a transferring gear. The driving shaft is pivotally connected to the body. The transferring gear is connected to the driving shaft. The driving gear set includes a wheel hub and a driving gear. The wheel hub is pivotally connected to the driving shaft of the transferring gear set. The driving gear is mounted on the wheel hub. The reversible gear set includes a reversible sleeve and a reversible gear. The reversible sleeve has a plurality of recesses therein and is pivotally connected to the hollow axle of the body. The reversible gear meshes with the transferring gear of the transferring gear set. The unidirectional gear set includes a follower gear, a unidirectional clutch and a unidirectional sleeve. The follower gear meshes with the driving gear of the driving gear set. The unidirectional clutch engages the reversible sleeve of the reversible gear set to the follower gear when the reversible sleeve of the reversible gear set rotates in a first direction and disengages the reversible sleeve of the reversible gear set from the follower gear when the reversible sleeve of the reversible gear set rotates in a second direction. The unidirectional sleeve is connected to the follower gear and has a plurality of recesses therein. The switcher includes a rod, a wedge and at least one spring. The rod passes through the hollow axle of the body. The spring applies resilience to the wedge and cooperates with the rod to move the wedge to engage the recesses of the unidirectional sleeve and the recesses of the reversible sleeve.

According to another embodiment of the present invention, a method for using the transmission includes moving the wedge to engage the recesses of the unidirectional sleeve and the recesses of the reversible sleeve by the switcher; reversely rotating the transferring gear set by pedals; rotating the reversible sleeve of the reversible gear set in the second direction by the rotational motion of the transferring gear of the transferring gear set; rotating the follower gear of the unidirectional gear set by the engagement of the reversible sleeve of the reversible gear set and the unidirectional sleeve of the unidirectional gear set; reversely rotating the driving gear set by the rotational motion of the follower gear.

### BRIEF DESCRIPTION OF THE DRAWINGS

FIG. 1 is a perspective view of a transmission according to one embodiment of the present invention;

FIG. 2 is a sectional view of the transmission of FIG. 1;

FIG. 3 is a sectional view of the transmission of FIG. 1; and

FIG. 4 is a three dimensional view of the transmission of FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

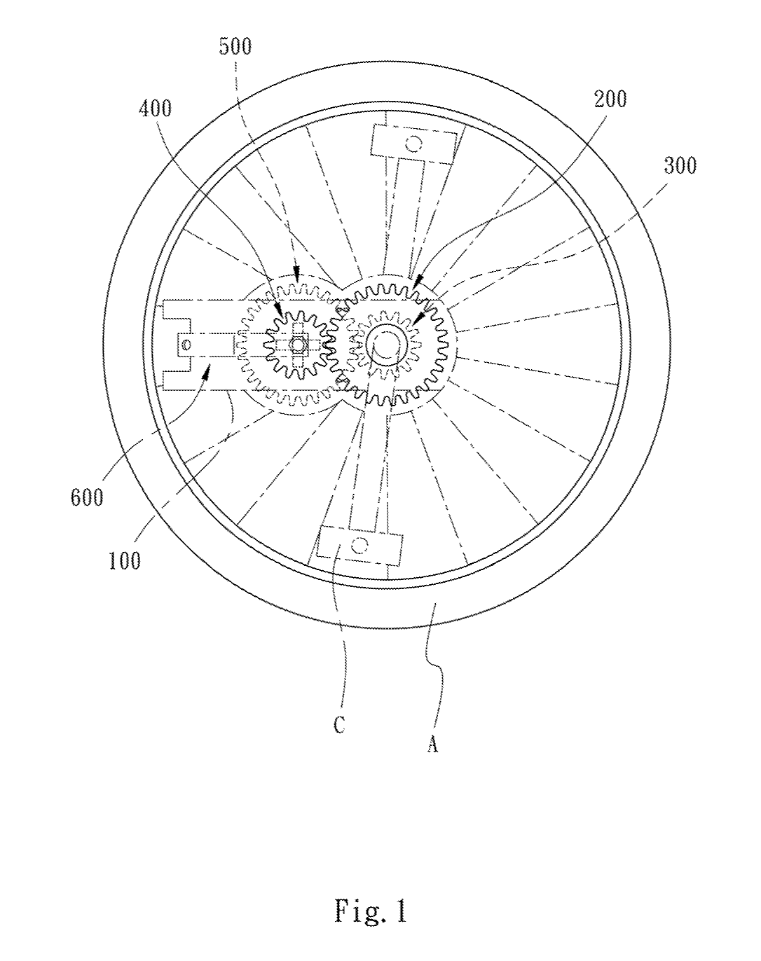

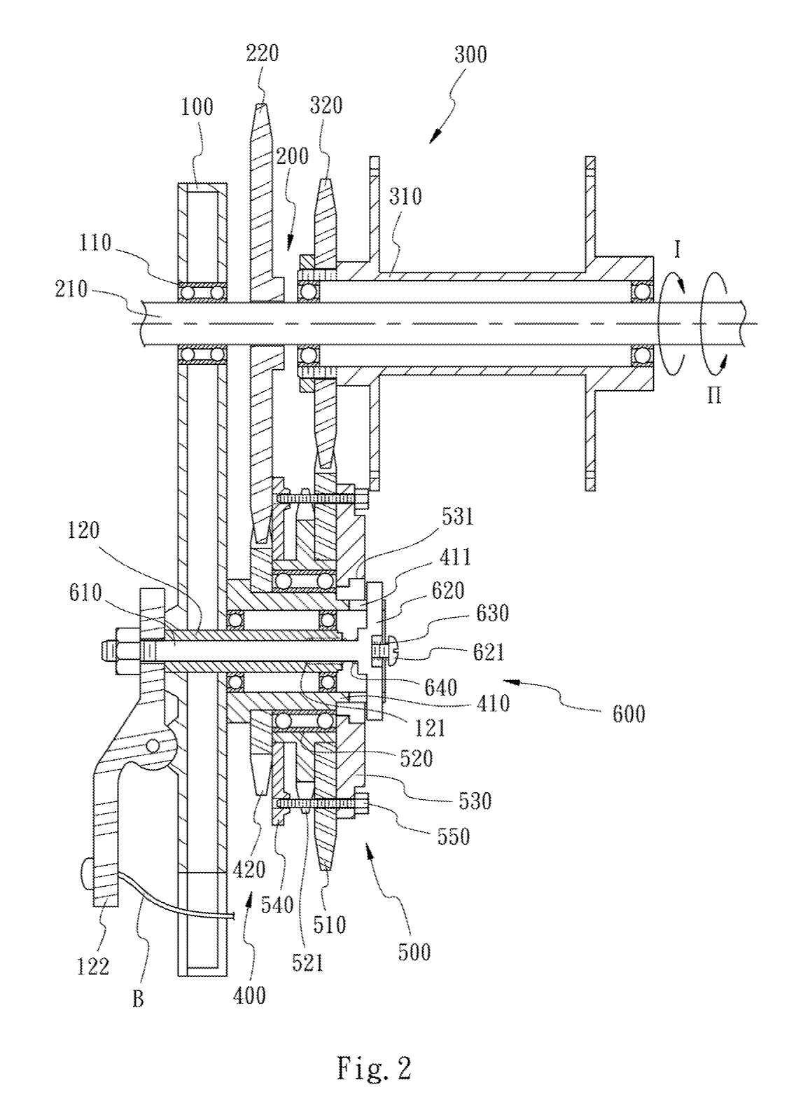

FIG. 1 is a perspective view of a transmission according to one embodiment. FIG. 2 is a sectional view of the transmission of FIG. 1. As shown in FIG. 1 and FIG. 2, the transmission is mounted on a wheel A of a vehicle such as a bicycle or pedal boat. The transmission includes a body 100, a transferring gear set 200, a driving gear set 300, a reversible gear set 400, a unidirectional gear set 500 and a switcher 600.

The body 100 has a hole 110 and a hollow axle 120. The hollow axle 120 is open-ended and has a terrace edge 121 facing the wheel A. The body 100 further includes a trigger 122 which is mounted on the body 100. One end of the trigger 122 is connected to the hollow axle 120 and the other end of the trigger 122 is connected to a wire B which is connected to the handle of the vehicle.

The transferring gear 200 set includes a driving shaft 210 and a transferring gear 220. The driving shaft 210 is pivotally connected to the body 100. The transferring gear 220 is connected to the driving shaft 210.

The driving gear set 300 includes a wheel hub 310 and a driving gear 320. The wheel hub 310 is pivotally connected to the driving shaft 210 of the transferring gear set 200 for driving the wheel A. The driving gear 320 is mounted on the wheel hub 310 and is parallel to the transferring gear 220 of the transferring gear set 200.

The reversible gear set 400 includes a reversible sleeve 410 and a reversible gear 420. The reversible sleeve 410 has four recesses 411 therein and the recesses 411 of the reversible sleeve 410 are equally spaced. The reversible sleeve 410 is pivotally connected to the hollow axle 120 of the body 100. The reversible gear 420 meshes with the transferring gear 220 of the transferring gear set 200.

The unidirectional gear set 500 includes a follower gear 510, a unidirectional clutch 520 and a unidirectional sleeve 530. The follower gear 510 meshes with the driving gear 320 of the driving gear set 300. The unidirectional clutch 520 engages the reversible sleeve 410 of the reversible gear set 400 to the follower gear 510 when the reversible sleeve 410 of the reversible gear set 400 is rotated in a first direction I. On the other hand, the is unidirectional clutch 520 disengages the reversible sleeve 410 of the reversible gear set 400 from the follower gear 510 when the reversible sleeve 410 of the reversible gear set 400 is rotated in a second direction II. The unidirectional sleeve 530 is connected to the follower gear 510 and has a plurality of recesses 531 therein.

The unidirectional gear set 500 further includes a disc 540, a plurality of screws 550 and a plurality of teeth 521. The disc 540 is mounted between the reversible gear 420 and the follower gear 510. The screws 550 are used to fasten the disc 540, the follower gear 510 and the unidirectional sleeve 530 together. The teeth 521 extends from the unidirectional clutch 520 to push the screws 550 so that the disc 540, the follower gear 510 and the unidirectional sleeve 530 will be rotated when the reversible sleeve 410 of the reversible gear set 400 is rotated in the first direction I.

The switcher 600 includes a rod 610, a cross-shaped wedge 620, a first spring 630 and a second spring 640. The rod 610 passes through the hollow axle 120 of the body 100. One end of the rod 610 is controlled by the trigger 122. The first spring 630 pressures the rod 610 to move the wedge 620 to engage the recess 531 against the other end of the rod 610 and the wedge 620. The second spring 640 is mounted between the terrace edge 121 and the wedge 620. The first spring 630 and the second spring 640 apply resilience to the wedge 620 and cooperate with the rod 610 to move the wedge 620 to engage the recesses 531 of the unidirectional sleeve 530 and the recesses 411 of the reversible sleeve 410.

Under the mode of moving forward, the follower gear 510 meshes with the driving gear 320 of the driving gear set 300. The unidirectional clutch 520 disengages the reversible sleeve 410 of the reversible gear set 400 from the follower gear 510. Therefore, the user can step on pedal C to drive the transferring gear 210 of the transferring gear set 200. The follower gear 510 of the unidirectional gear set 500 is rotated by the reversible gear 420 of the reversible gear set 400 drove by the transferring gear 210 of the transferring gear set 200. After that, the follower gear 510 drives the driving gear 320 of the driving gear set 300 to make the vehicle move forward. Because the unidirectional clutch 520 can only rotate in one direction, the unidirectional gear set 500 won't reverse to the follower gear 510. In this case, the transmission can go forward smoothly.

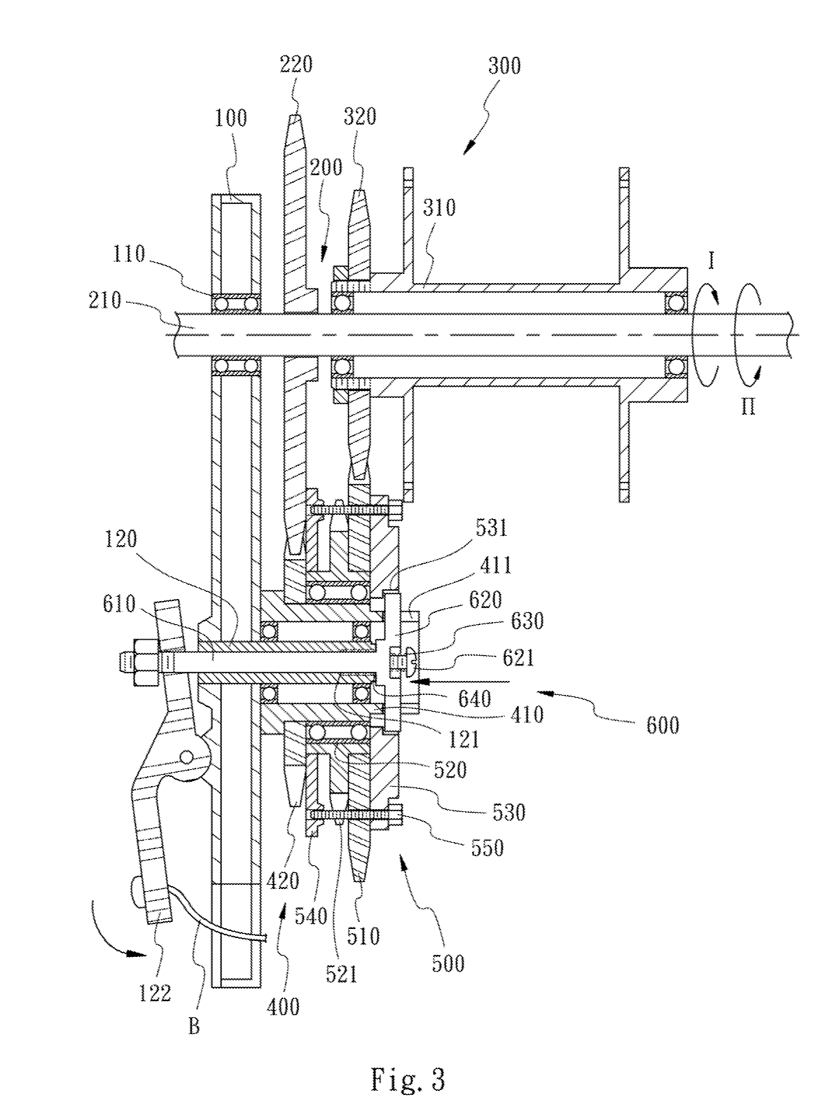

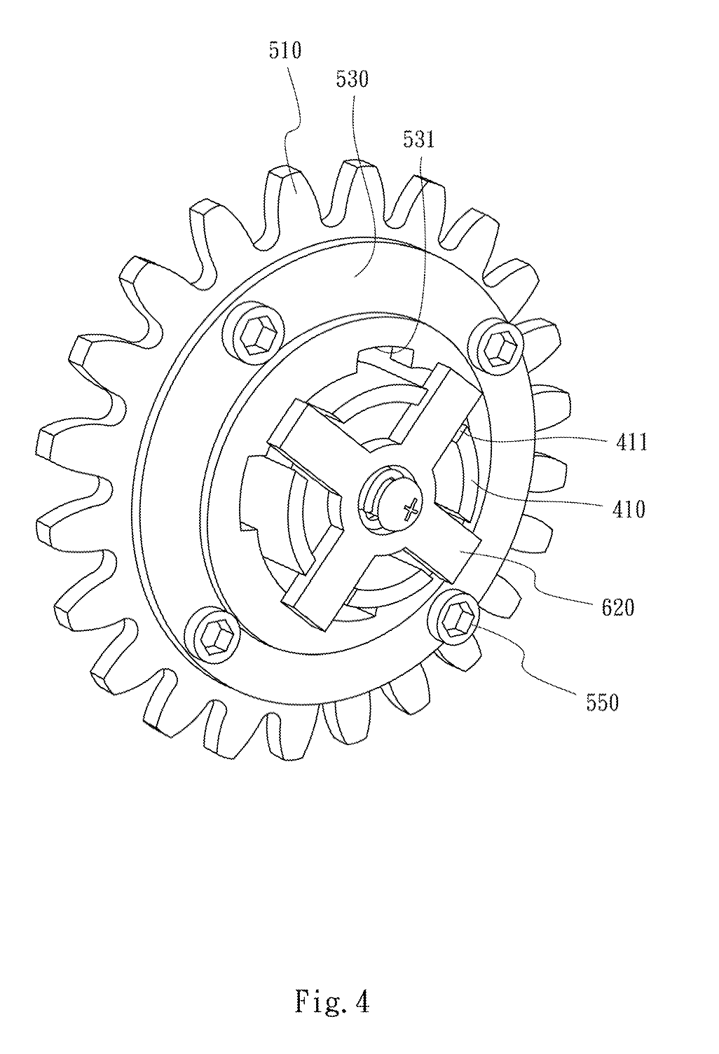

FIG. 3 is a sectional view of a transmission of FIG. 1. FIG. 4 is a three dimensional view of a transmission of FIG. 1. As shown in FIG. 3 and FIG. 4, the wedge 620 connects to the rod 610 controlled by the trigger 122. The user pushes the trigger 122 then moves the wedge 620 to engage four recesses 531 of the unidirectional sleeve 530 and those recesses 411 of the reversible sleeve 410. The unidirectional gear set 500 couples to the reversible gear set 400. Therefore, the unidirectional gear set 500 can rotate in the same directions with the reversible gear set 400. At this moment, the user can reversely rotate the transferring gear set 200 by pedal C and makes the vehicle move backward. After reversing the vehicle, the user can release the trigger 122 to move the wedge 620 disengaging the four recesses 531 of the unidirectional sleeve 530 and return to the forward mode.

According to the description above, there are some benefits to use the transmission as follow:

First, it is convenient to deal with the situations such as packaging goods, crossing waterlogged or narrow lanes, so users don't have to get out of the vehicles to then move it backward. In other words, the transmission can be switched, either the forward mode or the backward mode, depending on the user's needs.

Second, the backward mode of the transmission won't interfere with the forward mode so that it is safe to use the transmission.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims is not intended to invoke the provisions of 35 U.S.C. §112, 6th paragraph.

What is claimed is:

1. A transmission, comprising:
a body mounted on a wheel;
a transferring gear set comprising:
a driving shaft pivotally connected to the body; and
a transferring gear connected to the driving shaft;
a driving gear set comprising:
a wheel hub pivotally connected to the driving shaft of the transferring gear set for driving the wheel; and
a driving gear mounted on the wheel hub;
a reversible gear set comprising:
a reversible sleeve having a plurality of recesses therein and pivotally connected to the body; and
a reversible gear connected to the reversible sleeve and meshing is with the transferring gear of the transferring gear set;
a unidirectional gear set comprising:
a follower gear meshing with the driving gear of the driving gear set;
a unidirectional clutch for engaging the reversible sleeve of the reversible gear set to the follower gear when the reversible sleeve of the reversible gear set is rotated in a first direction I and disengaging the reversible sleeve of the reversible gear set from the follower gear when the reversible sleeve of the reversible gear set is rotated in a second direction; and
a unidirectional sleeve connected to the follower gear and having a plurality of recesses therein;
a wedge; and
a switcher to move the wedge to engage the recesses of the unidirectional sleeve and the recesses of the reversible sleeve.

2. The transmission of claim 1, wherein the driving gear of the driving gear set is parallel with the transferring gear of the transferring gear set.

3. The transmission of claim 1, wherein the number of the, recesses of the reversible sleeve is four, and the recesses of the reversible sleeve are equally spaced;
wherein the number of the recesses of the unidirectional sleeve is four, and the recesses of the unidirectional sleeve correspond to the recesses of the reversible sleeve; and
wherein the wedge is cross-shaped.

4. The transmission of claim 1, wherein the unidirectional gear set further comprising:
a disc mounted between the reversible gear and the follower gear;
a plurality of screws fastening the disc, the follower gear and the unidirectional sleeve together; and
a plurality of teeth extending from the unidirectional clutch to push the screws so that the disc, the follower gear and the unidirectional sleeve will be rotated when the reversible sleeve of the reversible gear set is rotated in the first direction.

5. The transmission of claim 1, further comprising:
two pedals mounted on opposite ends of the driving shaft of the transferring gear set.

6. A transmission, comprising:
a body having a hollow axle;
a transferring gear set comprising:
a driving shaft pivotally connected to the body; and
a transferring gear connected to the driving shaft;
a driving gear set comprising:
a wheel hub pivotally connected to the driving shaft of the transferring gear set; and
a driving gear mounted on the wheel hub;
a reversible gear set comprising:
a reversible sleeve having a plurality of recesses therein and pivotally connected to the hollow axle of the body; and
a reversible gear meshing with the transferring gear of the transferring gear set;
a unidirectional gear set comprising:
a follower gear meshing with the driving gear of the driving gear set;
a unidirectional clutch for engaging the reversible sleeve of the reversible gear set to the follower gear when the reversible sleeve of the reversible gear set is rotated in a first direction and disengaging the reversible sleeve of the reversible gear set from the follower gear when the reversible sleeve of the reversible gear set is rotated in a second direction; and
a unidirectional sleeve connected to the follower gear and having a plurality of recesses therein; and
a switcher comprising:
a rod passing through the hollow axle of the body;
a wedge; and
at least one spring applying resilience to the wedge and cooperating with the rod to move the wedge to engage the recesses of the unidirectional sleeve and the recesses of the reversible sleeve.

7. The transmission of claim 6, wherein the body further comprises a trigger connected and controlled by the hollow axle having a terrace edge facing to the wheel;
wherein the number of the recesses of the reversible sleeve is four, and the recesses of the reversible sleeve are equally spaced; and
wherein the wedge is cross-shaped and the switcher comprises a first spring for pressuring the rod to move the wedge to engage the recess against the end of the rod and the wedge; and a second spring mounted between the terrace edge and the wedge.

8. The transmission of claim 7, further comprising:
a wire connects to the trigger of the body and a handle of a vehicle.

9. The transmission of claim 7, further comprising:
two pedals mounted on both ends of the driving shaft of the transferring gear set.

10. A method for using the transmission of claim 1, comprising:
moving the wedge to engage the recesses of the unidirectional sleeve and the recesses of the reversible sleeve by the switcher;
reversely rotating the transferring gear set by pedals;
rotating the reversible sleeve of the reversible gear set in the second direction by the rotational motion of the transferring gear of the transferring gear set;
rotating the follower gear of the unidirectional gear set by the engagement of the reversible sleeve of the reversible gear set and the unidirectional sleeve of the unidirectional gear set; and
reversely rotating the driving gear set by the rotational motion of the follower gear.
